(19) United States
(12) Patent Application Publication
(10) Pub. No.: US 2025/0014537 A1
(43) Pub. Date: Jan. 9, 2025

(54) AUTOMATED SCALING AND DISPLAY PARAMETERS

(71) Applicant: Baker Hughes Holdings LLC, Houston, TX (US)

(72) Inventors: Sheldon McCrackin, Yukon, OK (US); Bryan David Maule, Camillus, NY (US); Matthew Joseph Ryan, Syracuse, NY (US); David James Yaw, Jamesville, NY (US)

(21) Appl. No.: 18/733,489

(22) Filed: Jun. 4, 2024

Related U.S. Application Data
(60) Provisional application No. 63/512,149, filed on Jul. 6, 2023.

(51) Int. Cl. G09G 5/373

(52) U.S. Cl. CPC G09G 5/373; G09G 2340/0407

(57) ABSTRACT

Data characterizing a video or image is received. The video or image is at a specified resolution. A scaling factor is determined based on the specified resolution and a resolution of a display. The data is displayed on the display at a fill-screen resolution or at a full-image resolution based on the determined scaling factor.

### CROSS REFERENCE TO RELATED APPLICATIONS

The present application claims benefit of priority to U.S. Patent Application No. 63/512,149, filed Jul. 6, 2023, and entitled “Automated Scaling and Display Parameters,” which is hereby incorporated by reference in its entirety.

### TECHNICAL FIELD

The subject matter described herein relates to displaying images and video on a screen.

### BACKGROUND

Images and videos do not always have the same resolution as displays used to display those images and videos. Various forms of scaling exist to properly display such images and videos. For example, an image can be scaled such that an entire image takes up as much of the screen as possible while maintaining its aspect ratio. In some instances, the image can be enlarged such that the image used the full resolution of the screen, even if portions of the image are cropped for such a fit.

### SUMMARY

This disclosure relates to automated scaling and display parameters.

An example implementation of the subject matter described herein is a method with the following features. Data characterizing a video or image is received. The video or image is at a specified resolution. A scaling factor is determined based on the specified resolution and a resolution of a display. The data is displayed on the display at a fill-screen resolution or at a full-image resolution based on the determined scaling factor.

The disclosed method can be implemented in a variety of ways. For example, within a system that includes at least one data processor and a non-transitory memory storing instructions for the processor to perform aspects of the method. Alternatively or in addition, the method can be in included non-transitory computer readable memory storing the method as instructions which, when executed by at least one data processor forming part of at least one computing system, causes the at least one data processor to perform operations of the method.

Aspects of the example method, which can be combined with the example method alone or in combination with other aspects, include the following. Determining the scaling factor includes the following. A specified resolution width of the data is determined. A specified resolution height of the data is determined. A resolution width of the display is determined. A resolution height of the display is determined. A width scaling factor is determined based on a ratio of the resolution width of the display to specified resolution width of the data. A height scaling factor is determined based on a ratio of resolution height of the display to the specified resolution height of the data. The smaller of the width scaling factor or the height scaling factor is determined to be the scaling factor.

Aspects of the example method, which can be combined with the example method alone or in combination with other aspects, include the following. The scaling factor is determined to be less than or equal to 1.35. The data is displayed at a fill-screen resolution.

Aspects of the example method, which can be combined with the example method alone or in combination with other aspects, include the following. The data displayed at the fill-screen resolution is saved as an image or video. The portions of the data not displayed at the fill-screen resolution are saved within metadata of the image or video.

Aspects of the example method, which can be combined with the example method alone or in combination with other aspects, include the following. The image or video is received. Portions of the metadata are determined to be representative of the saved portions of the data. A second image or video characterizing the data displayed at the full-image resolution is provided.

Aspects of the example method, which can be combined with the example method alone or in combination with other aspects, include the following. A scaling factor is determined to be greater than 1.35. The data is displayed at a full-image resolution.

Aspects of the example method, which can be combined with the example method alone or in combination with other aspects, include the following. A toggle option is displayed. A signal indicative of a toggle command is received. The display is alternated between the data at a fill-screen resolution and a full-image resolution responsive to the signal.

### BRIEF DESCRIPTION OF THE FIGURES

These and other features will be more readily understood from the following detailed description taken in conjunction with the accompanying drawings.

FIG. 1 is a flowchart of an example method that can be used with aspects of this disclosure.

FIG. 2 is an example of an image shown as being displayed full-image, and a description of determining a scaling factor;

FIG. 3 is an example image being shown at a fill-screen resolution;

FIG. 4 is an example of an image shown as being displayed full-image, and a description of determining a scaling factor;

FIG. 5 is an example image being shown at a fill-screen resolution; and

FIG. 6 is a block diagram of an example controller that can be used with aspects of this disclosure.

### DETAILED DESCRIPTION

Certain embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the present invention is defined solely by the claims. The features illustrated or described in connection with one embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

As images and videos often have a different resolution than a display screen on which they are displayed, the images and videos are often scaled to best fit the display screen. This disclosure describes how to determine whether to display an image or video in a full-image mode or a fill-screen mode.

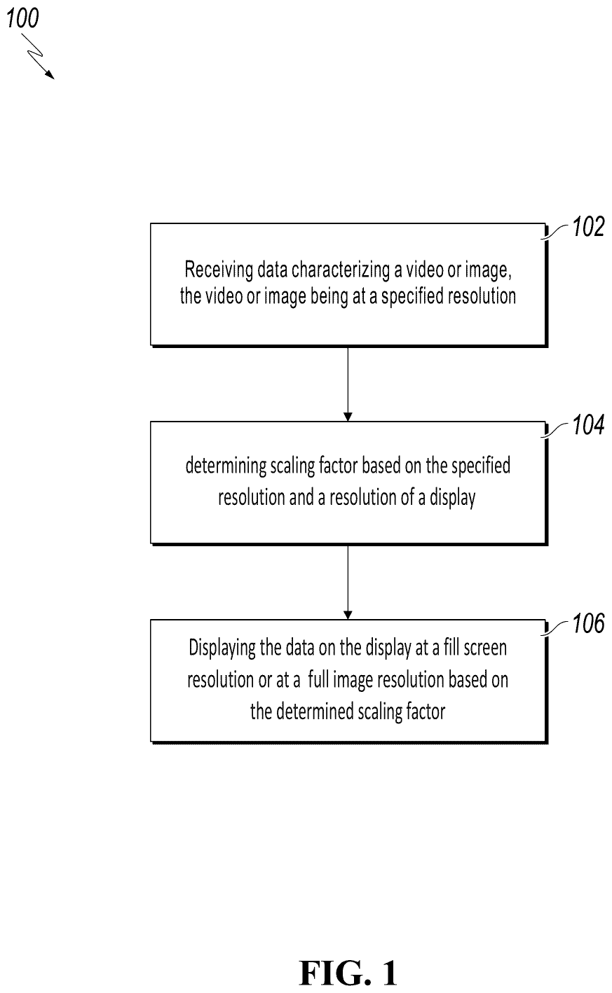

FIG. 1 is flowchart of an example method that can be used with aspects of this disclosure. At 102, data characterizing a video or image is received. The video or image has a specified resolution. In some implementations, the data characterizing the video or image is received from a non-destructive inspection device, for example a borescope.

At 104, a scaling factor is determined based on the specified resolution and a resolution of a display. In some instances, such a determination involves determining a specified resolution width of the data and a specified resolution height of the data. Similarly, a resolution width and a resolution height of the display can be determined. A width scaling factor and a height scaling factor can then be determines based on a ratio of the resolution width of the display to specified resolution width of the data and a ratio of resolution height of the display to the specified resolution height of the data, respectively. The smaller of the width scaling factor or the height scaling factor is determined to be the scaling factor.

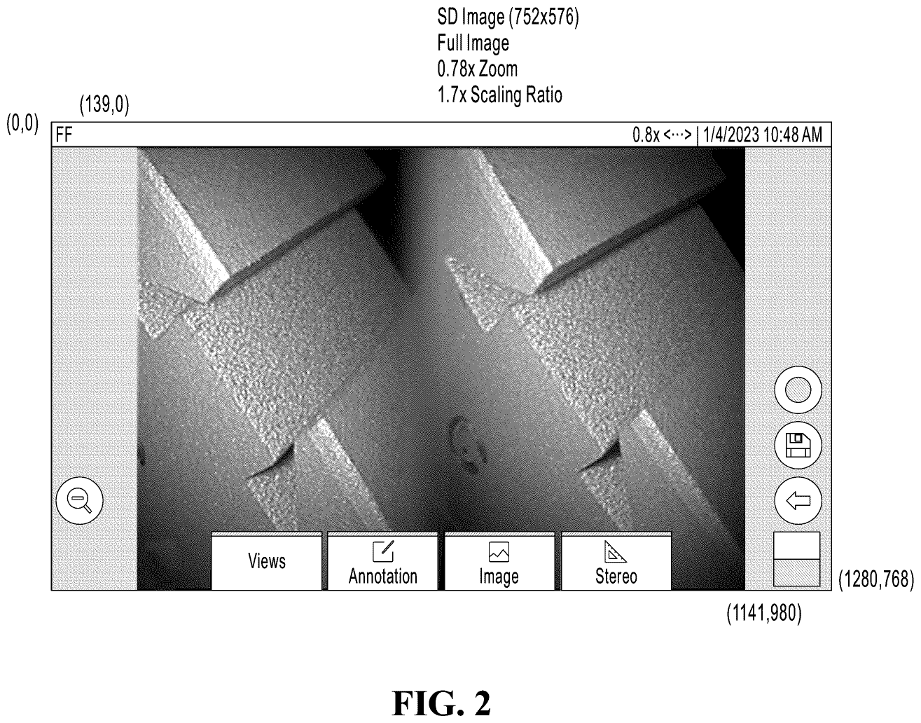

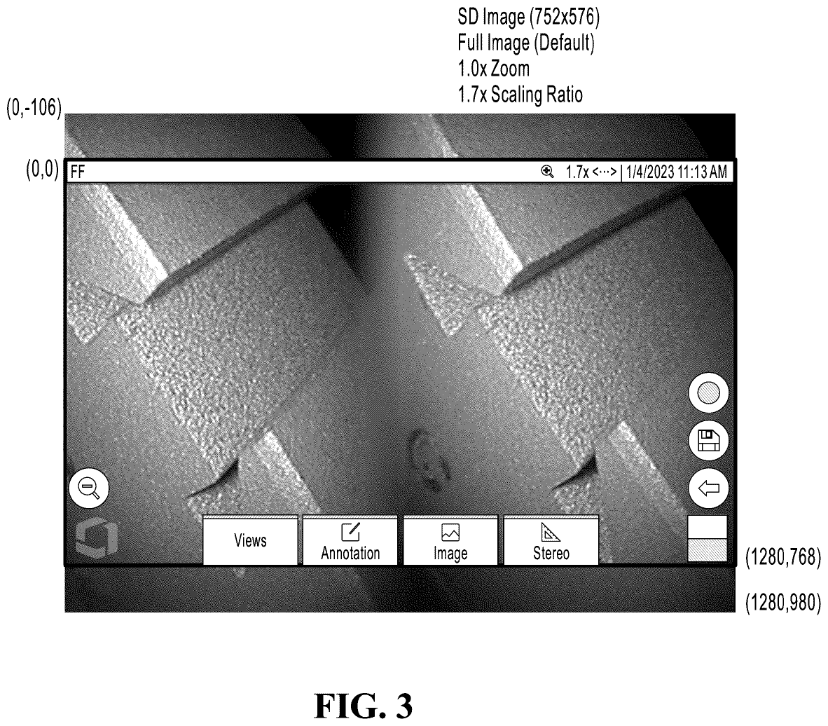

At 106, the data on is displayed the display at a fill-screen resolution or at a full-image resolution based on the determined scaling factor. An example of this method is shown in FIGS. 2-3. An image with a resolution of 752×576 pixels is received and is to be displayed on a display screen 200 that is 1280×768 pixels. The width scaling factor is the ratio of the width of the display to the width of the image, in this case about 1.7. The height scaling factor is the ratio of the height of the display to the height of the image, in this case, about 1.33. The smaller of the ratios is the height ratio of 1.33, so this value is used as the scaling factor for the entire image.

In this example (FIGS. 2-3), the scaling factor is determined to be less than or equal to 1.35. In such instances, the image can be displayed at a fill-screen resolution. In the context of this disclosure, fill-screen resolution means that the image is expanded to fill the entire display, as shown in FIG. 2, cutting off portions of the image. In some implementations, the image is substantially centered (within any rounding error of pixel scaling), with substantially equal amounts of the image being cut-off to fill the display (within any rounding error of pixel scaling). The aspect ratio of the image is maintained. The 1.35 ratio was chosen as the image or video has sufficient data for an image to remain clear and discernable to a viewer when using the 1.35 ratio as a dividing line between fill-screen and full-image resolutions.

In some implementations, portions of the image or video that are cut-off can be saved in metadata associated with the image or video. In such implementations, the fill-screen image is viewable to standard image/video viewers; however, when opened within the non-destructive inspection device or in an associated application configured to parse the metadata, the cut-off portions of the image or video can be recovered, for example, by toggling between fill-screen and full-screen modes. In some implementations, the image or video will be displayed in a state (full-screen or fill-screen) that the image was originally saved. In some implementations, the saved image includes annotations provided by an inspector.

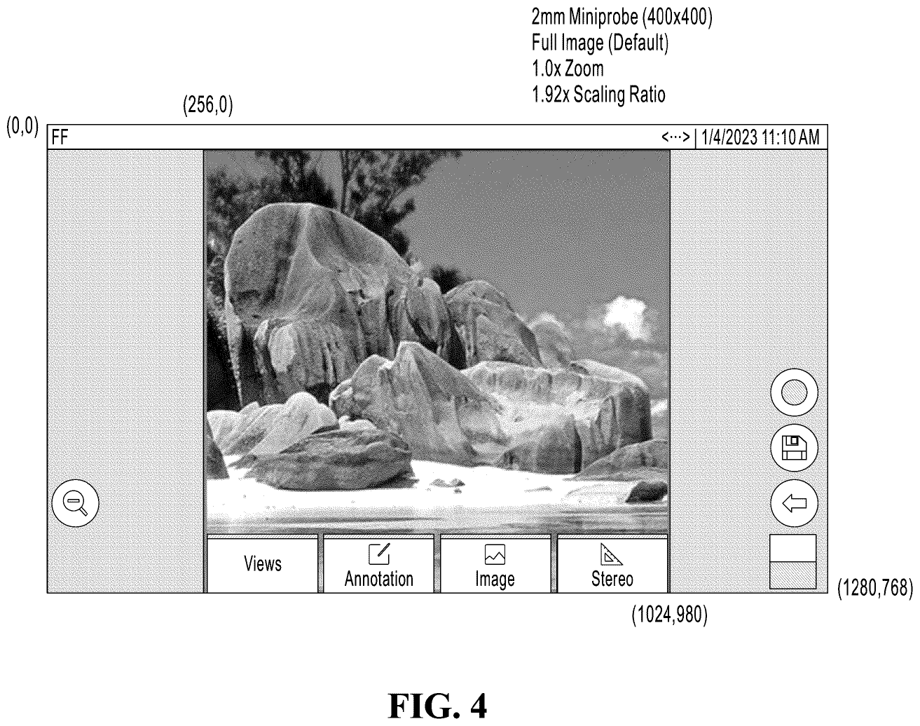

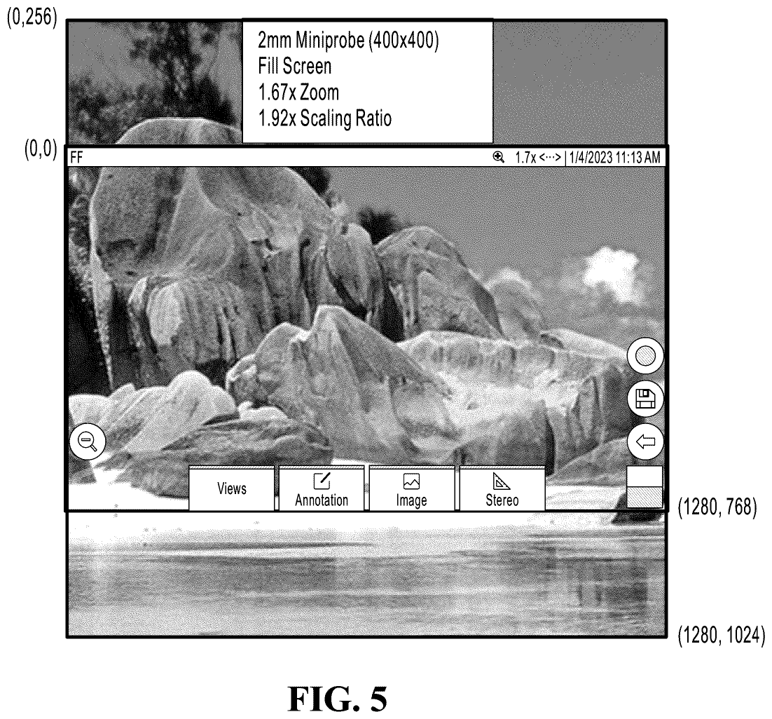

FIGS. 4-5 illustrate an example where the resulting ration is greater than 1.35. In this example, a 400×400 pixel image is to be displayed on a display 200 with a resolution of 1280×768. The width scaling factor in this case about 3.2, and the height scaling factor is about 1.92. The smaller of the ratios is the height ratio of 1.92, so this value is used as the scaling factor for the entire image.

In this example (FIGS. 4-5), the scaling factor is determined to be greater than 1.35. In such instances, the image can be displayed at a full-image resolution. In the context of this disclosure, full-image resolution means that the image is expanded to fill the display such that the entire image is visible and maintains its aspect ratio, as shown in FIG. 4, (within any rounding error of pixel scaling). The 1.35 ratio was chosen as the image or video has sufficient data for an image to remain clear and discernable to a viewer when using the 1.35 ratio as a dividing line between fill-screen and full-image resolutions.

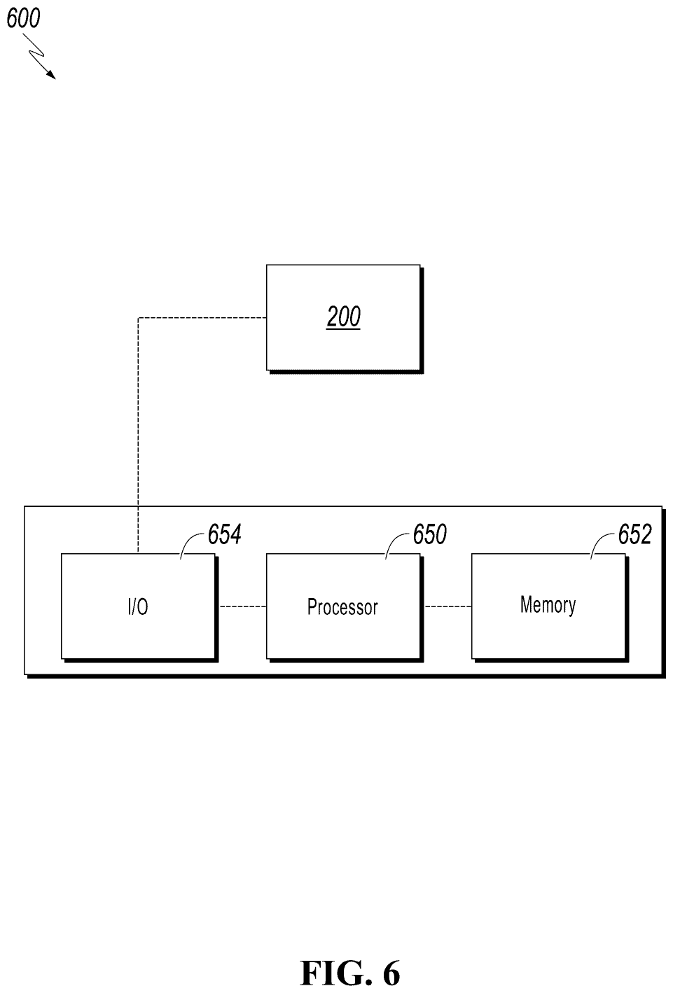

In some implementations, the display can include a toggle option allowing a user to switch between the fill-screen or full-image display options. In such instances, a signal indicative of a toggle command is received, for example, by a controller (FIG. 6). The view is alternated between displaying the data at a fill-screen resolution and a full-image resolution responsive to the signal.

Such determinations and renderings can be produced by a controller 500. Such an example controller is illustrated in FIG. 6. In some embodiments, the controller 600 can execute all or part of the method 100. The controller 600 can, among other things, monitor parameters of a system, send signals to actuate and/or adjust various operating parameters of such systems for example, a borescope. As shown in FIG. 6, the controller 600 can include one or more processors 650 and non-transitory computer readable memory storage (e.g., memory 652) containing instructions that cause the processors 650 to perform operations. The processors 650 are coupled to an input/output (I/O) interface 654 for sending and receiving communications with components in the system, including, for example, the screen 200 and a data source. In certain instances, the controller 600 can additionally communicate status with and send actuation and/or control signals to one or more of the various system components of the system, as well as other sensors (e.g., pressure sensors, temperature sensors, acoustic sensors, vibration sensors, image sensors and other types of sensors) that provide signals to the system. Other aspects of the method 100 can similarly be performed by the controller with various degrees of autonomy, for example, determining various features from an image or video can be scaled and displayed with no user input. Alternatively or in addition, a user can toggle between scaling and display options. Alternatively or in addition, a user can set the default ratio to determine the scaling and display defaults.

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
receiving data characterizing a video or image, the video or image being at a specified resolution;
determining scaling factor based on the specified resolution and a resolution of a display; and
displaying the data on the display at a fill-screen resolution or at a full-image resolution based on the determined scaling factor.

2. The method of claim 1, wherein determined the scaling factor comprises:
determining a specified resolution width of the data;
determining a specified resolution height of the data;
determining a resolution width of the display;
determining a resolution height of the display;
determining a width scaling factor based on a ratio of the resolution width of the display to specified resolution width of the data;
determining a height scaling factor based on a ratio of resolution height of the display to the specified resolution height of the data; and
determining the smaller of the width scaling factor or the height scaling factor to be the scaling factor.

3. The method of claim 1, further comprising:
determining the scaling factor is less than or equal to 1.35; and
displaying the data at a fill-screen resolution.

4. The method of claim 3, further comprising:
saving the data displayed at the fill-screen resolution as an image or video; and
saving portions of the data not displayed at the fill-screen resolution within metadata of the image or video.

5. The method of claim 4, further comprising:
receiving the image or video;
determining portions of the metadata that are representative of the saved portions of the data; and
providing a second image or video characterizing the data displayed at the full-image resolution.

6. The method of claim 2, further comprising:
determining a scaling factor is greater than 1.35; and
displaying the data at a full-image resolution.

7. The method of claim 1, further comprising:
displaying a toggle option;
receiving a signal indicative of a toggle command; and
alternating between displaying the data at a fill-screen resolution and a full-image resolution responsive to the signal.

8. A system comprising:
at least one data processor; and
non-transitory memory storing instructions, which, when executed by the at least one data processor causes the at least one data processor to perform operations comprising:
receiving data characterizing a video or image, the video or image being at a specified resolution;
determining scaling factor based on the specified resolution and a resolution of a display; and
displaying the data on the display at a fill-screen resolution or at a full-image resolution based on the determined scaling factor.

9. The system of claim 8, wherein determined the scaling factor comprises:
determining a specified resolution width of the data;
determining a specified resolution height of the data;
determining a resolution width of the display;
determining a resolution height of the display;
determining a width scaling factor based on a ratio of the resolution width of the display to specified resolution width of the data;
determining a height scaling factor based on a ratio of resolution height of the display to the specified resolution height of the data; and
determining the smaller of the width scaling factor or the height scaling factor to be the scaling factor.

10. The system of claim 8, wherein the instructions further cause the at least one data processor to perform operations comprising:
determining the scaling factor is less than or equal to 1.35; and
displaying the data at a fill-screen resolution.

11. The system of claim 10, wherein the instructions further cause the at least one data processor to perform operations comprising:
saving the data displayed at the fill-screen resolution as an image or video; and
saving portions of the data not displayed at the fill-screen resolution within metadata of the image or video.

12. The system of claim 11, wherein the instructions further cause the at least one data processor to perform operations comprising:
receiving the image or video;
determining portions of the metadata that are representative of the saved portions of the data; and
providing a second image or video characterizing the data displayed at the full-image resolution.

13. The system of claim 9, wherein the instructions further cause the at least one data processor to perform operations comprising:
determining a scaling factor is greater than 1.35; and
displaying the data at a full-image resolution.

14. The system of claim 8, wherein the instructions further cause the at least one data processor to perform operations comprising:
displaying a toggle option;
receiving a signal indicative of a toggle command; and
alternating between displaying the data at a fill-screen resolution and a full-image resolution responsive to the signal.

15. A non-transitory computer readable memory storing instructions which, when executed by at least one data processor forming part of at least one computing system, causes the at least one data processor to perform operations comprising:
receiving data characterizing a video or image, the video or image being at a specified resolution;
determining scaling factor based on the specified resolution and a resolution of a display; and
displaying the data on the display at a fill-screen resolution or at a full-image resolution based on the determined scaling factor.

16. The non-transitory computer readable memory of claim 15, wherein determined the scaling factor comprises:
determining a specified resolution width of the data;
determining a specified resolution height of the data;
determining a resolution width of the display;
determining a resolution height of the display;
determining a width scaling factor based on a ratio of the resolution width of the display to specified resolution width of the data;
determining a height scaling factor based on a ratio of resolution height of the display to the specified resolution height of the data; and
determining the smaller of the width scaling factor or the height scaling factor to be the scaling factor.

17. The non-transitory computer readable memory of claim 16, wherein the instructions further cause the at least one data processor to perform operations comprising:
determining the scaling factor is less than or equal to 1.35; and
displaying the data at a fill-screen resolution.

18. The non-transitory computer readable memory of claim 15, wherein the instructions further cause the at least one data processor to perform operations comprising:
saving the data displayed at the fill-screen resolution as an image or video; and
saving portions of the data not displayed at the fill-screen resolution within metadata of the image or video.

19. The non-transitory computer readable memory of claim 18, wherein the instructions further cause the at least one data processor to perform operations comprising:
receiving the image or video;
determining portions of the metadata that are representative of the saved portions of the data; and
providing a second image or video characterizing the data displayed at the full-image resolution.

20. The non-transitory computer readable memory of claim 16, wherein the instructions further cause the at least one data processor to perform operations comprising:
further comprising:
determining a scaling factor is greater than 1.35; and
displaying the data at a full-image resolution.

21. The non-transitory computer readable memory of claim 15, wherein the instructions further cause the at least one data processor to perform operations comprising:
further comprising:
displaying a toggle option;
receiving a signal indicative of a toggle command; and
alternating between displaying the data at a fill-screen resolution and a full-image resolution responsive to the signal.
